(19) United States
(12) Patent Application Publication
(10) Pub. No.: US 2018/0340821 A1
(43) Pub. Date: Nov. 29, 2018

(54) MICROSCOPIC TOMOGRAPHY DEVICE BASED ON LIGHT-SHEET AND SINGLE-PIXEL IMAGING

(71) Applicant: TSINGHUA UNIVERSITY, Beijing (CN)

(72) Inventors: Qionghai Dai, Beijing (CN); Liheng Bian, Beijing (CN); Feng Chen, Beijing (CN); Jinli Suo, Beijing (CN)

(21) Appl. No.: 15/819,570

(22) Filed: Nov. 21, 2017

(30) Foreign Application Priority Data
May 24, 2017 (CN) 201710375618.X

(51) Int. Cl. G01J 1/44; G01J 1/08; G02B 21/26; G02B 21/06; G02B 21/36

(52) U.S. Cl. CPC G01J 1/44; G01J 1/08; H04N 13/0253; G02B 21/26; H04N 2213/001; G02B 21/361; G02B 21/365; G01J 2001/4466; G02B 21/06

(57) ABSTRACT

A microscopic tomography device based on light-sheet and single-pixel imaging is provided. The device includes: a light source; a pattern modulator, configured to modulate light from the light source into different illumination patterns; a light modulator, configured to modulate the illumination patterns as patterned light sheets; a detector, configured to detect the light passing through the sample after the sample is illuminated by the patterned light sheets; a focusing lens, configured to focus the light passing through the sample onto the detector; and a reconstruction component, configured to reconstruct an image of the sample at the illuminated depth using the illumination patterns, corresponding measurements and a single-pixel imaging algorithm.

### CROSS-REFERENCE TO RELATED APPLICATIONS

This application is based on and claims priority to Chinese Patent Application No. 201710375618.X, filed on May 24, 2017, the entire contents of which are incorporated herein by reference.

### TECHNICAL FIELD

The present disclosure relates to the field of optics and computational photography, and more particularly, to a microscopic tomography device based on light-sheet and single-pixel imaging.

### BACKGROUND

An optical fluorescence microscope is configured to magnify small-sized samples (e.g. on nano-micro scale) such that microstructures (such as cells or bacterium) can be visible. When the fluorescein-labeled sample is illuminated by incident light with a given wavelength, fluorescence will be activated from the fluorescein due to an atomic energy level transition, such that the sample which cannot be directly seen will be visible.

Further, a light-sheet fluorescence microscopy is a three-dimensional microscopic fluorescence tomography technique. Incident light from a light source is spatially modulated to obtain a light sheet. The light sheet illuminates the sample laterally, to activate a thin layer at a certain depth of the sample. Fluorescence emitted from the thin layer proceeds along an optical axis perpendicular to the illumination plane, and is collected by a detector above or below the sample. In this way, no fluorescence is activated from portions of the sample that are above and below the illumination plane. By scanning images produced correspondingly at different depths, a three-dimensional tomographic image stack is obtained.

### SUMMARY

Embodiments of the present disclosure provide a microscopic tomography device based on light-sheet and single-pixel imaging. The device includes: a light source; a pattern modulator, configured to modulate light from the light source into different illumination patterns; a light modulator, configured to modulate the illumination patterns as patterned light sheets; a detector, configured to detect the light passing through the sample after it is illuminated by each patterned light-sheet at a certain depth; a focusing lens, arranged between the sample and the detector and configured to focus the light passing through the sample onto the detector; and a reconstruction component, configured to reconstruct an image of the sample at the illuminated depth using the illumination patterns and corresponding one-dimensional measurements obtained by the detector.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

The above or additional aspects and advantages of embodiments of the present disclosure will become apparent and more readily appreciated from the following descriptions made with reference to the drawings, in which:

FIG. 1 is a block diagram illustrating a microscopic tomography device based on light-sheet and single-pixel imaging according to embodiments of the present disclosure.

### DETAILED DESCRIPTION

Embodiments of the present disclosure will be described below, in which examples of the embodiments are illustrated in the drawings. The same or similar elements and the elements having same or similar functions are denoted by like reference numerals throughout the descriptions. The embodiments described herein with reference to drawings are explanatory, used to understand the present disclosure, and not construed to limit the present disclosure.

In the specification, it is to be understood that, terms such as “central”, “longitudinal”, “lateral”, “above”, “below”, “front”, “rear”, “right”, “left”, “horizontal”, “vertical”, “top”, “bottom” “inner”, “outer”, “lower”, “upper”, “up”, as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In the description of the present disclosure, unless specified or limited otherwise, the terms “mounted,” “connected,” “coupled” and “fixed” and variations thereof are used broadly and encompass such as fixed, removable mountings, connections and couplings, or may be integral; also may be mechanical or electrical mountings, connections and couplings; also can be direct or indirect mountings, connections and couplings, or further may be inner mountings, connections and couplings or interaction relation of two components, which can be understood by those skilled in the art according to the detail embodiment of the present disclosure.

Referring to the following descriptions and drawings, these and other aspects of the embodiments of the present disclosure will be apparent. In these descriptions and drawings, some specific approaches of the embodiments of the present disclosure are provided, so as to show some ways to perform the principle of the embodiments of the present disclosure, however it should be understood that the embodiment of the present disclosure is not limited thereby. Instead, the embodiments of the present disclosure comprise all the variants, modifications and their equivalents within the spirit and scope of the present disclosure as defined by the claims.

Now, embodiments of the present disclosure will be described with reference to drawings.

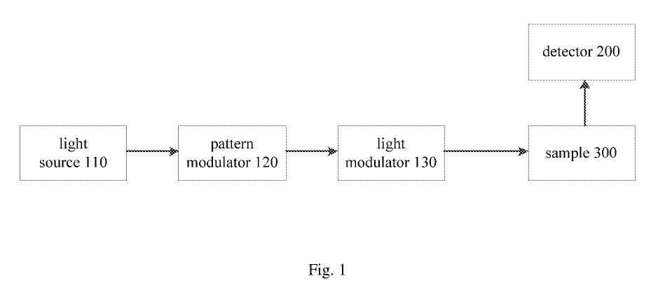

FIG. 1 is a block diagram illustrating a microscopic tomography device based on light-sheet and single-pixel imaging. As illustrated in FIG. 1, the device includes a light source 110, a pattern modulator 120, a light modulator 130, a detector 200, a focusing component (not illustrated), and a reconstruction component (not illustrated).

The pattern modulator 120 is configured to modulate the light from the light source 110 into different illumination patterns. In an embodiment of the present disclosure, the light from the light source 110 may be modulated by the pattern modulator 120 to form different illumination patterns by using a rotation stage, together with altering a scanning galvanometer, using a DMD (Digital Micro-mirror Device) or using an acousto-optic tunable filter. The rotation stage is further configured to rotate the sample, in which way the illumination patterns can be of different directions.

The light modulator 130 is configured to modulate the illumination patterns as patterned light sheets. In an embodiment of the present disclosure, the illumination patterns may be modulated by the light modulator 130 using a cylindrical lens or using a modulation method with a Gaussian or Bessel function, to produce patterned light sheets. The patterned light sheets may be regarded as a lighting end for subsequent single-pixel imaging.

The detector 200 is configured to detect the light passing through the sample after the sample 300 is illuminated by the patterned light sheets. After the sample is illuminated by a number of patterned light sheets with different patterns, a sequence of single-pixel signals may be detected by the detector 200. In an embodiment of the present disclosure, the detector 200 is one of a photodiode and a SPAD (single photon avalanche diode) detector. The photodiode is of wide spectrum range, low cost, and high signal-to-noise ratio. The SPAD detector has an advantage of a high sensitivity.

The focusing component is arranged between the sample and the detector 200, and is configured to focus the light passing through the sample onto the detector 200. It is of low cost to use a focusing lens.

The reconstruction component is configured to reconstruct an image of the sample at the illuminated depth using the illumination patterns and the measurements obtained by the detector 200 based on the single-pixel imaging technique. The reconstruction algorithm is one of the compressive sensing based optimization algorithms, the gradient descent optimization algorithms and the linear correlation based algorithms.

By using the single-pixel imaging technique, the device according to embodiments of the present disclosure owns a wide spectrum range, low cost and high signal-to-noise ratio. By focusing the light passing through the sample onto the detector, the image quality is not influenced by a scattering distortion. Therefore, the device according to embodiments of the present disclosure has a strong robustness to optical scattering distortions.

Furthermore, other elements of the microscopic tomography system may be similar to those known in the art, which are not elaborated for reducing redundancy.

In the description of the present disclosure, reference throughout this specification to “an embodiment,” “some embodiments,” “example,” “a specific example,” or “some examples,” means that a particular feature, structure, material, or characteristic described in connection with the embodiment or example is included in at least one embodiment or example of the present disclosure. In the specification, the terms mentioned above are not necessarily referring to the same embodiment or example of the present disclosure. Furthermore, the particular features, structures, materials, or characteristics may be combined in any suitable manner in one or more embodiments or examples. Besides, any different embodiments and examples and any different characteristics of embodiments and examples may be combined by those skilled in the art without contradiction.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A microscopic tomography device based on light-sheet and single-pixel imaging, comprising:
a light source;
a pattern modulator, configured to modulate light from the light source into different illumination patterns;
a light modulator, configured to modulate the illumination patterns as patterned light sheets;
a detector, configured to detect the light passing through the sample after it is illuminated by each of the patterned light-sheets at a certain depth;
a focusing lens, arranged between the sample and the detector and configured to focus the light passing through the sample onto the detector; and
a reconstruction component, configured to reconstruct an image of the sample at the illuminated depth using the illumination patterns and corresponding one-dimensional measurements obtained by the detector.

2. The device according to claim 1, wherein the pattern modulator is configured to modulate the light from the light source into different illumination patterns by using a rotation stage, together with altering a scanning galvanometer, using a digital micro-mirror device (DMD) chip or using an acousto-optic tunable filter, the rotation stage is further configured to rotate the sample, in which way the illumination patterns is of different directions.

3. The device according to claim 1, wherein the light modulator is configured to modulate the illumination patterns through a cylindrical lens or a modulation method with a Gaussian or Bessel function.

4. The device according to claim 1, wherein the detector is one of a photodiode and a single photon avalanche diode SPAD detector.

5. The device according to claim 1, wherein the reconstruction component is configured to reconstruct an image using the illumination patterns, measurements and a reconstruction algorithm derived in the single-pixel imaging technique.

6. The device according to claim 5, wherein the reconstruction algorithm is one of a compressive sensing based optimization algorithms, a gradient descent optimization algorithms or a linear correlation based algorithms.
